(19) United States
(12) Patent Application Publication
(10) Pub. No.: US 2004/0146191 A1
(43) Pub. Date: Jul. 29, 2004

(54) Auxiliary system for plastic surgery

(76) Inventor: Tung-Wu Lu, Chung-He City (TW)

Correspondence Address: CHARLES E. BAXLEY, ESQ., 90 JOHN STREET, THIRD FLOOR, NEW YORK, NY, 10038, US

(21) Appl. No.: 10/759,880

(22) Filed: Jan. 16, 2004

(30) Foreign Application Priority Data
Jan. 20, 2003 (CN) 092101084

(51) Int. Cl. G06K 9/00

(52) U.S. Cl. 382/128; 382/154

(57) ABSTRACT

The present invention relates to a precise auxiliary system for plastic surgery with less human caused error, wherein a three-dimensional geometry data capturing device is used to acquire correct three-dimensional geometry data of patient's part to be operated, a database and an operational analysis device are employed to work out correct data, furthermore, a error-compensation device is used to assistant the surgeon in planning the plastic operation, so as to provide precise plastic operation result with less human error. The auxiliary system for plastic surgery is further capable of providing optimum commutation between patient and surgeon, wherein a three-dimensional display device is provided for displaying the condition before and after plastic surgery in three-dimensional effect. Patient and surgeon can fully communicate with each other without photos and oral explanations.

### BACKGROUND OF THE INVENTION

1. Field of the Invention

The present invention relates to a precise auxiliary system for plastic surgery with less human caused errors, and more particularly to an auxiliary system comprising a three-dimensional (3D) geometric data capturing device, a 3D display device, a database and an analysis device, which is capable of providing optimal communication between surgeons and patients.

2. Description of the Prior Arts

Conventional techniques for plastic surgery refer to photo-comparisons, eye-measurements and measurements with simple instruments based on surgeon's experience, and then the surgery is performed according to the patient's request. These conventional techniques have been used in the area of plastic surgery for a long period of time. However, there are still some defects that can be caused during surgeries, which are explained as follows:

First, it is difficult for the plastic surgeon to decide the size, height and volume of the implant to be implanted before surgery, such as breast or nose augmentation.

Second, before procedures such as liposuction, abdominoplasty or other kinds, the plastic surgeon would have difficulties in locating the part to be operated without proper assistive tools.

Third, the communication between surgeon and patient based on the conventional techniques only can resort to photo description and comparison. Patients are unable to predict or imagine the appearances after surgery, and the surgeon also has not any precise auxiliary system that can display personal aesthetic standard and the anticipated surgical results. Thus, the plastic surgery is susceptible to imperfect results due to insufficient communication between patient and surgeon or the inexperience of the surgeon.

Fourth, the implants and operated parts such as in nose or breast augmentation are subject to gravitational force, and the appearance of the implanted body parts under gravity is the real result of the plastic operation, however, so far there is no precise auxiliary system capable of displaying the anticipated result before plastic surgery (taking the gravitational effects on both the implant and operated part into consideration).

The present invention has arisen to mitigate and/or obviate the afore-described disadvantages of the conventional techniques for plastic operation.

### SUMMARY OF THE INVENTION

The primary object of the present invention is to provide a precise auxiliary system for plastic surgery with less human caused errors, wherein a three-dimensional (3D) geometric data capturing device is used to acquire correct 3D geometric data of the patient's part to be operated, a database, an analysis device and an error-compensation device are employed to work out correct geometric data post-surgery, furthermore, together with the aforementioned devices, a 3D display device is used to assist the surgeon in planning the plastic operation, so as to provide precise plastic operation results with less human error.

The secondary object of the present invention is to provide an auxiliary system for plastic operation capable of providing optimum commutation between the patient and surgeon, wherein a 3D display device is used for displaying the condition before and after plastic operation in 3D effect. The patient and surgeon can fully communicate with each other without confusions commonly caused in using photos and oral explanations.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a schematic plan of an auxiliary system for plastic surgery in accordance with the present invention;

FIG. 2 is a flow chart of the present invention;

FIG. 3 is an illustrative view of a breast augmentation.

### DETAILED DESCRIPTION OF THE PREFERRED EMBODIMENT

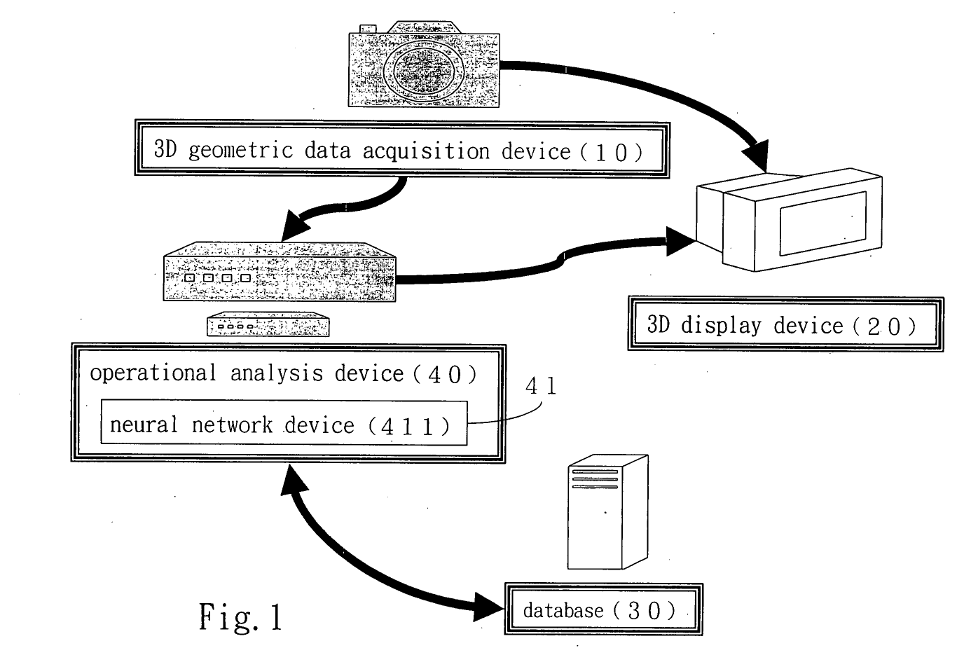

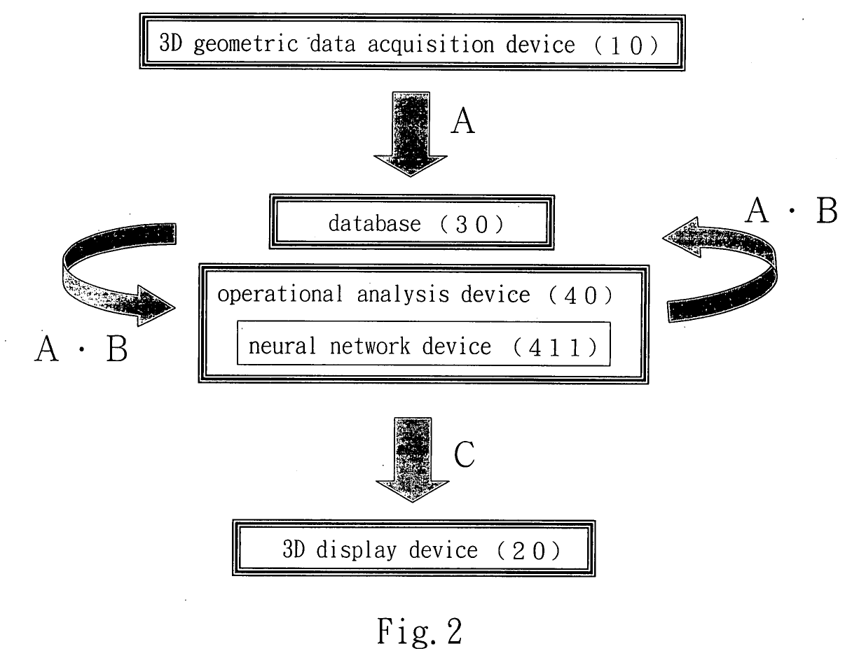

Referring to FIGS. 1 and 2, an auxiliary system for plastic surgery in accordance with one aspect of the present invention generally comprises of a three-dimensional (3D) geometric data capturing device 10, a 3D display device 20, a database 30 and an analysis device 40.

The 3D geometric data acquisition device 10 is a 3D geometric data capturing equipment based on stereophotogrammetric or 3D scanning techniques capable of acquiring 3D profile data of the part to be operated. The 3D geometric data capturing device 10 can be in the form of different kinds of equipments, including common medical imaging equipments such as stereophotogrammetric equipment, computerized tomography (CT), 3D scanner, X-ray imaging devices, ultrasonic scanning system, magnetic resonance imaging (MRI), and the likes, all the above-mentioned equipments and devices are capable of acquiring 3D geometric data through 3D reconstruction of the acquired images.

The 3D display device 20 is provided with a 3D display capability and capable of displaying the data acquired by the 3D geometric data capturing device 10 with complete 3D effect. Computer display, film output and photo output devices are the conventional 3D display devices used in the medical circles.

The database 30 is a storage medium pre-stored with a vast amount of data, including the data and outcome (3D geometric data) of operations categorized by patient and/or surgeon that have been performed in the past.

The analysis device 40 is a set of data-operation device serving to process the data of the 3D geometric data capturing device 10 and the database 30. The analysis device 40 is further coupled with an error-compensation device 41, which in this embodiment is in the form of an artificial neural network (ANN) device 411. The error-compensation device 41 refers to the error correction through preinstalled equations (such as those governing the mechanics of the human tissue and those for the laws of mechanics). Based on the 3D geometric data, the equations for human tissue mechanics and laws of mechanics and gravity, the analysis device 40 is able to predict the true shape of the human body part under gravity given the information of the implants and body part shape pre-operation, and then the data of the true human body shape is displayed using the 3D display device 20. The error-compensation device 41 (artificial neural network device 411 in this embodiment) will correct the error by taking into consideration of the patient's body weight and tissue properties, the surgeon's skills and previous experiences. By such arrangement, the present invention can produce an effect of artificial intelligence-like auxiliary system for plastic operation, and with the help of the artificial intelligence-like auxiliary system, the problem of the communication between patient and surgeon can be solved.

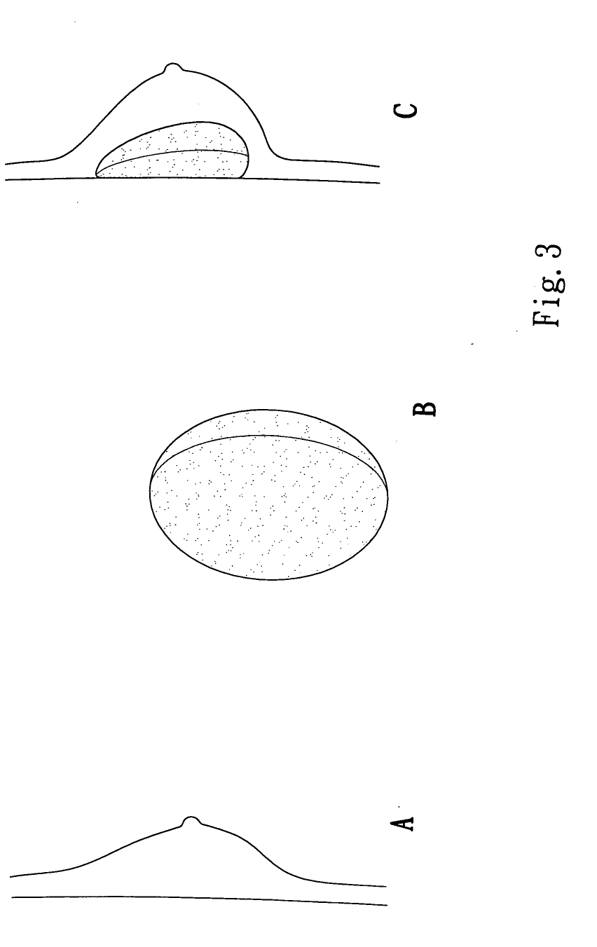

Referring to FIG. 3, which is an illustrative view of a breast augmentation. During the breast augmentation, the 3D geometric data capturing device 10 initially collect the 3D data of the pre-surgical breast shape (A) by taking advantage of stereophotogrammetric or 3D scanning techniques, and then input the 3D data of the pre-surgical breast shape (A) into the database 30. At this moment, the analysis device 40 will proceed calculations based on the 3D data of the pre-operational breast shape (A) captured with the 3D geometric data capturing device 10 and the data of the shape of an implant B stored in the database 30. In the meanwhile, based on human tissue mechanics and laws of mechanics and gravity, the analysis device 40 is able to predict the data of the breast's shape post-operation. After that, the artificial neural network device 411 is employed to correct the error by taking into consideration of the patient's body weight, tissue properties and the surgeon's skills and previous experiences (the above-mentioned data are stored in the database 30). Furthermore, the artificial neural network device 411 can be connected to different databases 30 through network. And thus, the different databases 30 all over the world can conduct multiple experience corrections, and then the analysis device 40 will transmit the post-correction data of the true implanted breast shape (C) to the 3D display device. 20. The data of true implanted breast shape (C) shown on the 3D display device 20 provides a good communication between the surgeon and patient. Furthermore, with the assistance of the data from the database 30, the equations of tissue mechanics and gravity in the analysis device 40 and the error-correction technique of the artificial neural network device 411, the true implanted breast shape (C) closest to the operation result can be shown on the 3D display device 20.

It is noted that not only can the present invention provide a learning function using artificial intelligence, namely ANN, for surgery planning and outcome prediction (such as showing the results obtained from sophisticated calculations using equations of tissue mechanics and laws of mechanics as well as the artificial neural network for error-compensation for best communication between the patient and the surgeon), it can also preserve all the surgical details of the patient, including body weight and tissue properties, surgeon's skill levels and previous experiences in the database. In this case, the data of the database 30 will accumulate and grow constantly, so the present invention has a self-learning function. For continuing learning, every patient and surgeon will leave their own data in the database 30 before and after operation. In this case, the artificial neural network device 411 is able to carry out an artificial intelligent operation based on previously learned knowledge associated with the patient's body weight, tissue constitution, surgeon's skill levels, previous experiences and clinical outcome (the above-mentioned data are stored in the database 30). The artificial neural network device 411 can compensate effects due to such errors as from the mechanical calculations and 3D geometry data by using theories of statistics and error-compensation, it can also produce an optimum predicated outcome based on the data of the respective surgeon's skill level and characteristics, so as to bring the predicated value before operation closest to the true operation result. Thereby, the present invention is an auxiliary system for plastic operation, which is able to help surgeon to make a precise operation.

In addition to the artificial neural network device 411, the error-compensation device 41 in accordance with the present invention can also be in the form of a statistical analysis device, which makes predictions based on statistical analysis of previous data on the patient's body properties, surgeon's skill level and previous experiences. With the assistance of the statistics analysis device, statistical analysis can be carried out among different databases stored with huge amount of operation data and results, so as to provide an optimum auxiliary data for the surgeon.

While we have shown and described an embodiment in accordance with the present invention, it should be clear to those skilled in the art that further embodiments may be made without departing from the scope of the present invention.

What is claimed is:

1. An auxiliary system for plastic surgery comprising:
a three-dimensional (3D) geometric data capturing device being a 3D geometry data capturing equipment based on stereophotogrammetric and 3D scanning techniques capable of acquiring and storing 3D geometric data of patient's body parts to be operated;
a 3D display device provided with a 3D display capability and capable of displaying the 3D geometric data acquired by the 3D geometric data capturing device with 3D effects;
a database being a storage medium pre-stored with a vast amount of data, including data and effect of previous operations that have been performed in the past;
an analysis device serving to process the 3D geometric data of the 3D geometric data capturing device and the data of the database, the analysis device additionally provided with an error-compensation device, based on equations of human tissue mechanics and laws of mechanics and gravity, the analysis device being able to work out data about human body's shape under gravity with or without implants, and then the data of the human body shape being transmitted to and shown on the 3D display device, the error-compensation device employed to correct errors of the predicted data of the human body shape based on patient's body constitution, tissue properties, surgeon's skill level and experiences of previous operations.

2. The auxiliary system for plastic surgery as claimed in claim 1, wherein the error-compensation device of the analysis device is a statistics analysis device, the statistics analysis device performs experienced-based error-compensation based on data of single database or different databases and techniques of the equations of gravity and patient body properties of the analysis device.

3. The auxiliary system for plastic surgery as claimed in claim 1, wherein the error-compensation device is an artificial neural network device which is used to perform experience-based error-compensation based on data of single database or different databases and the technique of the gravity equation of the analysis device.

4. The auxiliary system for plastic surgery as claimed in claim 3, wherein the artificial neural network device can be connected to different databases through network, so as to perform experience analysis and corrections using different databases all over the world.

5. The auxiliary system for plastic surgery as claimed in claim 1, wherein the 3D geometric data capturing device is 3D scanning equipment.

6. The auxiliary system for plastic surgery as claimed in claim 1, wherein the 3D geometric data capturing device is stereophotogrammetric equipment.

7. The auxiliary system for plastic surgery as claimed in claim 1, wherein the 3D geometric data capturing device is computerized tomography.

8. The auxiliary system for plastic surgery as claimed in claim 1, wherein the 3D geometric data capturing device is X-ray photographic device.

9. The auxiliary system for plastic surgery as claimed in claim 1, wherein the 3D geometric data capturing device is ultrasonic scanner.

10. The auxiliary system for plastic surgery as claimed in claim 1, wherein the 3D geometric data capturing device is magnetic resonance imaging equipment.

11. The auxiliary system for plastic surgery as claimed in claim 1, wherein the 3D display device is computer display.

12. The auxiliary system for plastic surgery as claimed in claim 1, wherein the 3D display device is film-output device.

13. The auxiliary system for plastic surgery as claimed in claim 1, wherein the 3D display device is photo-output device.
